(19) United States
(12) Patent Application Publication
(10) Pub. No.: US 2005/0123886 A1
(43) Pub. Date: Jun. 9, 2005

(54) Systems and methods for personalized karaoke

(76) Inventors: Xian-Sheng Hua, Beijing (CN); Lie Lu, Beijing (CN); Hong-Jiang Zhang, Beijing (CN)

Correspondence Address: LEE & HAYES PLLC, 421 W RIVERSIDE AVENUE SUITE 500, SPOKANE, WA, 99201, US

(21) Appl. No.: 10/723,049

(22) Filed: Nov. 26, 2003

(51) Int. Cl. G10H 7/00

(52) U.S. Cl. 434/307 A

(57) ABSTRACT

Systems and methods are described that implement personalized karaoke, wherein a user's personal home video and photographs are used to form a background for the lyrics during a karaoke performance. An exemplary karaoke apparatus is configured to segment visual content to produce a plurality of sub-shots and to segment music to produce a plurality of music sub-clips. Having produced the visual content sub-shots and music sub-clips, the exemplary karaoke apparatus shortens some of the plurality of sub-shots to a length of a corresponding music sub-clip from within the plurality of music sub-clips. The plurality of sub-shots is then displayed as a background to lyrics associated with the music, thereby adding interest to a karaoke performance.

### RELATED APPLICATIONS

This patent application is related to:

U.S. patent application Ser. No. 09/882,787, titled “A Method and Apparatus for Shot Detection”, filed on Jun. 14, 2001, commonly assigned herewith, and hereby incorporated by reference.

U.S. patent application Ser. No. ______, titled “Systems and Methods for Generating a Comprehensive User Attention Model”, filed on Nov. 1, 2002, commonly assigned herewith, and hereby incorporated by reference.

This patent application is related to U.S. patent application Ser. No. 10/286,348, titled “Systems and Methods for Automatically Editing a Video”, filed on Nov. 1, 2002, commonly assigned herewith, and hereby incorporated by reference.

This patent application is related to U.S. patent application Ser. No. 10/610,105, titled “Content-Based Dynamic Photo-to-Video Methods and Apparatuses”, filed on Jun. 30, 2003, commonly assigned herewith, and hereby incorporated by reference.

This patent application is related to U.S. patent application Ser. No. 10/405,971, titled “Visual Representative Video Thumbnails Generation”, filed on Apr. 1, 2003, commonly assigned herewith, and hereby incorporated by reference.

### TECHNICAL FIELD

The present disclosure generally relates to audio and video data. In particular, the disclosure relates to systems and methods of integrating audio, video and lyrical data in a karaoke application.

### BACKGROUND

Karaoke is a form of entertainment originally developed in Japan, in which an amateur performer(s) sings a song to the accompaniment of pre-recorded music. Karaoke involves using a machine which enables performers to sing while being prompted by the words (lyrics) of the song which are displayed on a video screen that is synchronized to the music. In most applications, letters of the words of the song will turn color or be highlighted at the precise time during which they should be sung. In this manner, amateur singers are spared the burden of memorizing the lyrics to the song. As a result, the performance of the amateur singers is substantially enhanced, and the experience is greatly enhanced for the audience.

In some applications, a photograph may be shown by the video in the background, i.e. behind the lyrics of the song. The photograph provides added interest to the audience. However, the content of the video on the screen is provided, such as by video tapes, disks or other media, in a pre-recorded format. Accordingly, the video content is fixed, and the performer (and audience) is essentially stuck with the images that are pre-recorded in conjunction with the lyrics of the song.

The following systems and methods address the limitations of known karaoke systems.

### SUMMARY

Systems and methods are described that implement personalized karaoke, wherein a user's personal home video and photographs are used to form a background for the lyrics during a karaoke performance. An exemplary karaoke apparatus is configured to segment visual content to produce a plurality of sub-shots and to segment music to produce a plurality of music sub-clips. Having produced the visual content sub-shots and music sub-clips, the exemplary karaoke apparatus shortens some of the plurality of sub-shots to a length of a corresponding music sub-clip from within the plurality of music sub-clips. The plurality of sub-shots is then displayed as a background to lyrics associated with the music, thereby adding interest to a karaoke performance.

### BRIEF DESCRIPTION OF THE DRAWINGS

The same reference numerals are used throughout the drawings to reference like components and features.

FIG. 1 is a block diagram showing elements of exemplary components and their relationship.

FIG. 2 is a table showing an exemplary frame difference curve (FDC).

FIG. 3 illustrates an exemplary lyric service and its relationship to a karaoke apparatus.

FIG. 4 illustrates exemplary operation of a karaoke apparatus.

FIG. 5 illustrates exemplary handling of shots and sub-shots obtained from video.

FIG. 6 illustrates exemplary operation wherein attention analysis is applied to a video sub-shot selection process.

FIG. 7 illustrates exemplary processing of shots obtained from photographs.

FIG. 8 illustrates exemplary processing of music sub-clips.

FIG. 9 illustrates exemplary processing of lyrics and related information.

FIG. 10 is a block diagram of an exemplary computing environment within which systems and methods to for personalized karaoke may be implemented.

### DETAILED DESCRIPTION

Exemplary Personalized Karaoke Structure

In an exemplary personalized karaoke apparatus, visual content, such as personal home videos and photographs, are automatically selected from users' video and photo databases. The visual content, including video and photographs, are used in the background—behind the lyrics—in a karaoke system. Because the visual content is unique to the user, the user's family and the user's friends, the visual content personalizes the karaoke, adding interest and value to the experience.

Selection of particular video shots and photographs is made according to their content, the users' preferences and the type of music with which the visual content will be used. The available video content is filtered to allow selection of items of highest quality, interest level and applicability to the music. Lyrics are typically obtained from a lyrics service, and are generally delivered over the internet. In some implementations, a database of available lyrics may be accessed using a query-by-humming technology. Such technology operates by allowing the user to hum a few bars of the song, whereupon an interface to the database returns one or more possible matches to the song hummed. In other implementations, the database of available lyrics is accessed by keyboard, mouse or other graphical user interface.

The selected video clips, photographs and lyrics are displayed during performance of the karaoke song, with transitions between visual content coordinated according to the rhythm, melody or beat of the music. To enhance the experience, selected photographs are converted into motion photo clips by a Photo2Video technology, wherein camera angles change, zoom and pan the photo.

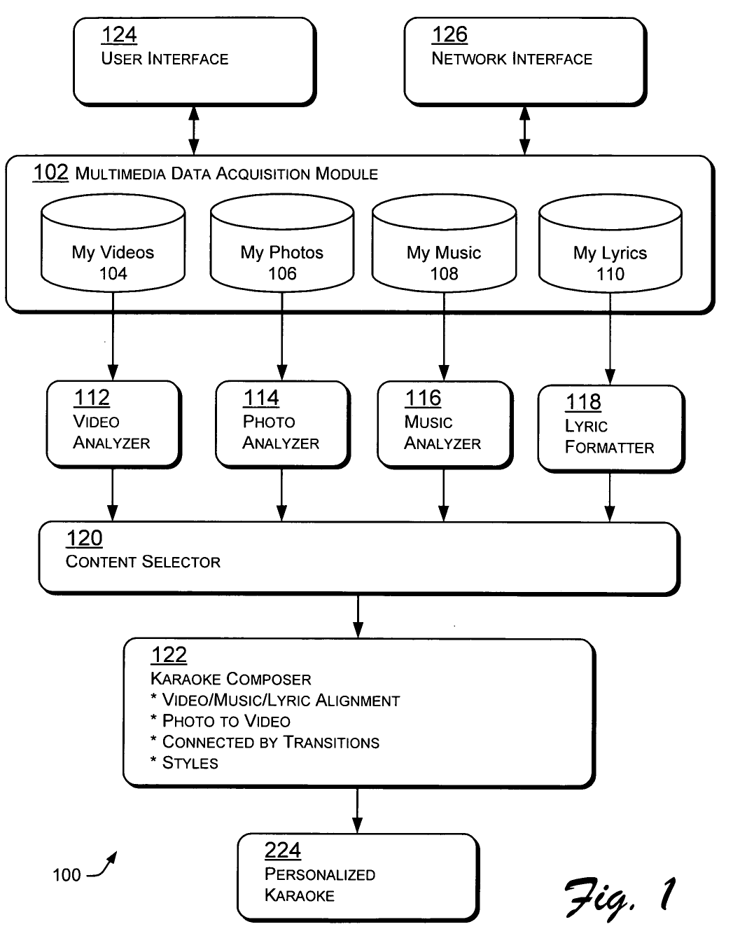

FIG. 1 is a block diagram showing elements of exemplary components of a personalized karaoke apparatus 100 and their relationship. A multimedia data acquisition module 102 is configured to obtain visual content including videos and photographs, as well as music and lyrics. In the exemplary implementation shown, my videos 104 and my photos 106 are typically folders defined on a local computer disk, such as on the user's personal computer. My videos 104 and my photos 106 may contain a number of videos such as home movies, and photographs such as from family photographic albums. In a preferred implementation, the visual content is in a digital format, such as that which results from a digital camcorder or a digital camera. Accordingly, to access visual content, the multimedia data acquisition module 102 typically accesses the folders 104, 106 on the user's computer's disk drive.

My music 108 and my lyrics 110 may be similar folders defined on the user's computer's hard drive. However, because songs and lyrics are copyrighted, and because they are not widely available, the user may wish to obtain both from a service. Accordingly, my music 108 and my lyrics 110 may be remotely located on a database which can provide karaoke songs (typically songs without lead vocalists) and karaoke lyrics. Such a database may be run by a karaoke service, which may use the Internet to sell or rent karaoke songs and karaoke lyrics to users. Accordingly, to access my music 108 and my lyrics 110, the multimedia data acquisition module 102 typically may access the folders 108, 110 on the user's computer's disk drive. Alternatively, as seen in FIG. 3, the multimedia data acquisition module 102 (FIG. 1) may communicate over the Internet 302 with a music service 300 to obtain karaoke songs and karaoke lyrics for use on the karaoke apparatus 100.

The format within which the lyrics are contained within my lyrics 110 is not rigid; several formats may be envisioned. An exemplary format is seen in Table 1, wherein the lyrics may be configured in an XML document.

TABLE 1

<Lyric>

<Group type = “solo” name =“singer1”>

<Sentence start = “ ” stop =“ ”)

<syllable start = “ ” stop =“ ” value = “ ” />
<syllable start = “ ” stop =“ ” value = “ ” />
<syllable start = “ ” stop =“ ” value = “ ” />
. . . . . . . . .

</Sentence>
<Sentence start = “ ” stop =“ ”
. . . . . . . . .
</Sentence>
. . . . . . . . . . .

</Group>
<Group type =“solo” name = “singer2”>
. . . . . . . . . . . . . .
</Group>
<Group type =“chorus” name =“singer1, singer 2”>

As seen in the exemplary code of Table 1, the lyrics for a karaoke song may be contained within an XML document contained within my lyrics 110. The XML document provides that each syllable of each word of the song be located between quotes after the term “value”, and that the start and stop times for that syllable are indicated between quotes after “start” and “stop”. Similarly, the start and stop times for each sentence are indicated. In this application, the sentence may indicate one line of text. Thus, the exemplary XML document provides the entire lyrics to a given song, as well as the precise time period wherein each syllable of each word in the lyrics should be displayed and highlighted during the karaoke song. Note that meta data is not shown in Table 1, but could be included to show artist, title, year of initial recording, etc.

A video analyzer 112 is typically configured in software. The video analyzer 112 is configured to analyze home videos, and may be implemented using a structure that is arranged in three components or software procedures: a parsing procedure to segment video temporally; an importance detection procedure to determine and to weight the video (or more generally, visual content) shots and sub-shots according to a degree to which they are expected to hold viewer attention; and a quality detection procedure to filter out poor quality video. Based 11 on the results obtained by these three components, the video analyzer 112 selects appropriate or “important” video segments or clips to compose a background video for display behind the lyrics during the karaoke performance. The technologies upon which the video analyzer 112 is based are substantially disclosed in the references cited and incorporated by reference, above.

The video analyzer 112 obtains video—typically amateur home video obtained from my videos 104—and breaks the video into shots. Once formed, the shots may be grouped to form scenes, and may be subdivided to form sub-shots. The parsing may be performed using the algorithms proposed in the references cited and incorporated by reference, above, or by other known algorithms. For raw home videos, most of the shot boundaries are simple cuts, which are much more easily detected than are the shot boundaries associated with professionally edited videos. Accordingly, the task of segmenting video into shots is typically easily performed. Once a transition between two adjacent shots is detected, the video temporal structure is further analyzed, such as by using by the following approach.

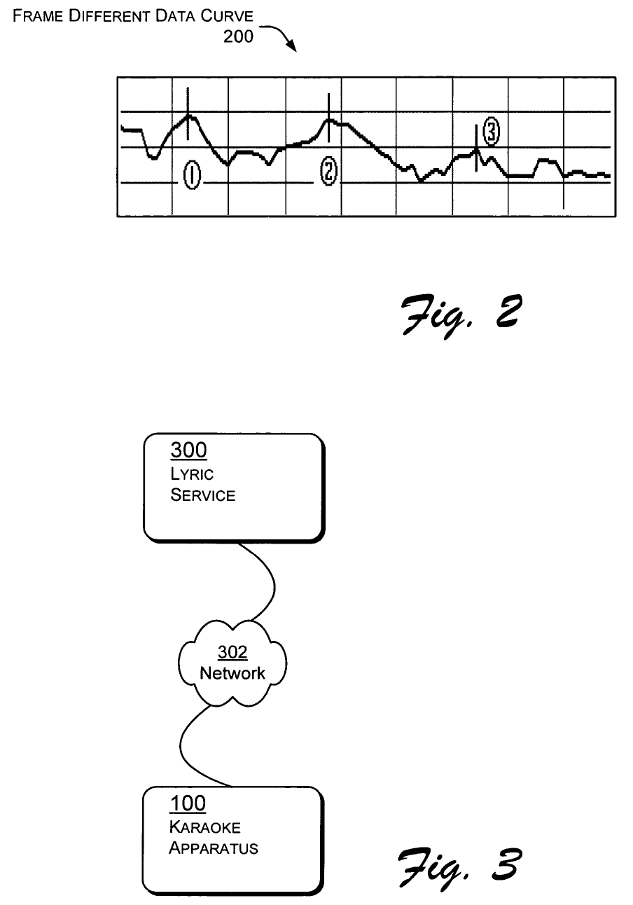

First, the shot is divided into smaller segments, namely, sub-shots, whose lengths (i.e. elapsed time during sub-shot play-back) are in a certain range required by the composer 122, as will be seen below. This is accomplished by detecting the maximum of the frame difference curve (FDC), as shown in FIG. 2.

FIG. 2 shows elapsed time horizontally, and the magnitude of the difference between adjacent frames vertically. Thus, local maxima on the FDC tend to indicate camera movement which can indicate the boundary between adjacent shots or sub-shots. Continuing to refer to FIG. 2, it can be seen that three boundaries (labeled 1, 2 and 3) are located at the area wherein the difference between two adjacent frames is the highest.

By monitoring the difference between frames, the video analyzer 112 is able to determine logical locations at which a video shot may be segmented to form two sub-shots. In a typical implementation, a shot is cut into two sub-shots at the maximum peak (such as 1, 2 or 3 in FIG. 2), if the peak is separated from the shot boundaries by at least the minimum length of a sub-shot. This process by which shots are segmented into sub-shots may be repeated until the lengths of all sub-shots are smaller than the maximum sub-shot length. As will be seen below, the maximum sub-shot length should be somewhat longer in duration that the length of music sub-clips, so that the video sub-shots may be truncated to equal the length of the music sub-clips.

And second, the video analyzer 112 may be configured to merge shots into groups of shots, i.e., scenes. There are many scene grouping methods presented in the literature. In an exemplary implementation, a hierarchical method that merges the most “similar” adjacent scenes/shots step-by-step into bigger ones employed. Adjacent scenes/shots may be considered to be similar, as indicated by a “similarity measure.” The similarity measure can be taken to be the intersection of an averaged and quantized color histogram in HSV color space, wherein HSV is a kind of color space model which defines a color space in terms of three constituent components: hue (color type, such as blue, red, or yellow), saturation (the “intensity” of the color), and value (the brightness of the color). The stop condition, by which the merging of adjacent scenes/shots is halted, can be triggered by either the similarity threshold or the final scene numbers. The video analyzer 112 may also be configured to build higher level structure on scene, i.e., time, which is based on the time-code or timestamp of the shots. In this level, shots/scenes that shoot in the same time period are merged into one group.

The video analyzer 112 attempts to select “important” video shots from among the shots available. Generally, selecting appropriate or “important” video segments requires conceptual understanding of the video content, which may be abstract, known only to those who took the video, or otherwise difficult to discern. Accordingly, it is difficult to determine which shots are important within unstructured home videos. However, where the objective is creating a compelling background video for karaoke, it may not be necessary to completely understand the conceptual importance in the content of each video shot. As a more easily achieved alternative, the video analyzer 112 needs only determine those parts of the video more “important” or “attractive” than the others. Assuming that the most “important” video segments are those most likely to hold a viewer's interest, the task becomes how to find and model the elements that are most likely to attract a viewer's attention. Accordingly, the video analyzer 112 is configured to make video segment selection based on the idea of determining which shots are the more important or more attractive than others, without fully understanding the factors upon which the differences in importance are based.

In one implementation, the video analyzer 112 is configured to detect object motion, camera motion and specific objects, which principally include people's faces. Importance to a viewer, and the resultant attention the viewer pays, are neurobiological concepts. In computing the attention a viewer pays to various scenes, the video analyzer 112 is configured to break down the problem of understanding a live video sequence into a series of computationally less demanding tasks. In particular, the video analyzer 112 analyzes video sub-shots and estimates their importance to perspective viewers based on a model which supposes that a viewer's attention is attracted by factors including: object motion; camera motion; specific objects (such as faces) and audio (such as speech, audio energy, etc.).

As a result, one implementation of the video analyzer 112 may be configured to produce an attention curve by calculating the attention/importance index of each video frame. Importance index for each sub-shot is obtained by averaging the attention indices of all video fames within this sub-shot. Accordingly, sub-shots may be compared based on their importance and predicted ability to hold an audience's attention. As a byproduct, motion intensity, and camera motion (type and speed) for each sub-shot, is also obtained.

The video analyzer 112 is also configured to detect the video quality level of shots, and therefore to compare shots on this basis, and to eliminate shots having poor video quality from selection. Since most home videos are recorded by unprofessional home users operating camcorders, there are often low quality segments in the recordings. Some of those low quality segments result from incorrect exposure, an unsteady camera, incorrect focus settings, or because the users forgot to turn off camera, resulting in time during which floors or walls are unintentionally recorded. Most of these low quality segments that are not caused by camera motion can be detected by examining their color entropy. However, sometimes, good quality video frames also have low entropies, such as in videos of skiing events. Therefore, an implementation of the video analyzer 112 combines both motion analyses with the entropy approach, thereby reducing false assumptions of poor video quality. That is, the video analyzer 112 considers segments to possibly be of low quality only when both entropy and motion intensity are low. Alternatively, the video analyzer 112 may be configured with other approaches for detecting incorrectly exposed segments, as well as low quality segments caused by camera shaking.

For example, very fast panning segments caused by rapidly changing viewpoints, and fast zooming segments are detected by checking camera motion speed. The video analyzer 112, as configured above, filters from the selection these segments, since they are not only blurred, but also lack appeal.

A photo analyzer 114 is typically configured in software. The photo analyzer 114 may be substituted for, or work in conjunction with, the video analyzer 112. Accordingly, the background for the karaoke lyrics can include video from my videos 104 (or other source), photos from my photos 106, or both. The photo analyzer 114 is configured to analyze photographs, and may be implemented using a structure that is arranged in three components or software procedures: a quality filter to identify poor-quality photos; a grouping function to attractively group compatible photographs; and a focal area detector, to detect a focal-area or interest-area that is likely grab the attention of the karaoke audience.

In one implementation, the photo analyzer 114 uses photo grouping only when using photographs. However, where the video analyzer 112 and photo analyzer 114 are both used, each photograph may be regarded as a video shot (which contain only one sub-shot, i.e., the shot itself), and then use video scene grouping to form groups. In an even more general sense, video and photographs, both having shots and sub-shots, may be considered to be visual content, also having shots and sub-shots. In that case, photo importance is the entropy of the quantized HSV color histogram.

Since most of the photographs within my photos 106 were taken by unprofessional home users, they frequently include many low quality photographs, having one or more of the following faults: Under or over exposed images, e.g., the photographs that are taken when the exposure parameters were not correctly set. This problem can be detected by checking whether the average brightness of the photograph is too low or too high. Homogenous images, e.g., floor, wall. This problem can be detected by checking whether the color entropy is too low. These photographs always have no salient object in which user may have interest. Blurred photographs. This problem can be detected by know methods.

While some of the problems above could be alleviated, repaired or adjusted, the photo analyzer 114 is typically configured to discard the photo from consideration. Accordingly, further discussion assumes that the photo analyzer 114 has eliminated photos having the above faults from consideration, i.e. such flawed photos are removed from consideration by the photo analyzer 114.

One implementation of the photo analyzer 114 uses a three-criterion procedure to group photographs into three tiers. That is, photographs are grouped by: the date the photo was taken; the scene within the photo; and if the photo is a member of a group of very similar photographs. The first criterion, i.e., the date, allows discovery of all photographs taken on a certain date. The date may be obtained from the metadata of digital photographs, or from OCR results from analog photographs that have date stamps. If none of these two kinds of information can be obtained, the date on which the file was created is used. The second criterion, the scene, represents a group of photographs that, while not as similar as those which fall under the third criterion, were taken at the same time and place.

The photo analyzer 114 uses photos falling within the scope of the first two criteria. Accordingly, date and scene will be used to determine transition types and support editing styles, as to be explained later. Photos falling under the third criteria, that is falling within a group of very similar photos, are filtered out (except, possibly, for one such photograph). Groups of very similar photographs are result when photographers often take several photographs for the same or nearly the same object or scene. By eliminating such groups of photos, the photo analyzer 114 prevents boring periods of time during the karaoke performance.

In one embodiment of the photo analyzer 114, photographs are firstly grouped into a top-tier labeled ‘day’ based on the date information. Then, a hierarchical clustering algorithm with different similarity thresholds is used to group the lower two layers. In particular, photographs with a lower degree of similarity are grouped together as a “scene.” Another group of photographs is formed having a higher degree of similarity.

The photo analyzer 114 may be configured to time-constrain the lower two layers. For time constrained grouping, each group contains photographs in a certain period of time. There is no time overlap between different groups. The photo analyzer 114 may use time and order of photograph creation to assist in clustering photos, i.e. photograph groups may consist of temporally contiguous photographs. Where the photo analyzer 114 includes a content-based clustering algorithm using best-first probabilistic model merging, it performs rapidly and yields clusters that are often related by content.

If no time constraint is needed, the photo analyzer 114 may be configured to group photographs according to their content similarity only. Accordingly, the photo analyzer 114 may use a simple hierarchical clustering method for grouping, and an intersection of HSV color histogram may be used as a similarity measure of two photographs or two clusters of photographs.

The photo analyzer 114 may be configured for “focus element detection,” i.e. the detection of an element within the photograph upon which viewers will focus their attention. Focus element detection is the preparation step for photo to video, which will be described with more detail, below. The focus detection technologies used within the photo analyzer 114 can include those disclosed in documents incorporated by reference, above.

The photo analyzer 114 recognizes focal elements in the photographs that most likely attract viewers' attention. Typically human faces are more attractive than other objects, so the photo analyzer 114 employs a face or attention area detector to detect areas, e.g. an “attention area,” to which people may directed their attention, such as toward dominant faces in the photographs. A limit, such as 100 pixels square, on the smallest face recognized, typically results in more attractive photo selection. As will be seen in greater detail below, the focal element(s) are the target area(s) within the photographs wherein a simulated camera will pan and/or zoom.

The photo analyzer 114 may also employ a saliency-based visual attention model for static scene analysis. Based on the saliency map obtained by this method, separate attention areas/spots are then obtained, where the saliency map indicates that the area/spots exceed a threshold. Attention areas that have overlap with faces are removed.

A music analyzer 116 is typically configured in software. The music analyzer 116 may be configured with technology from the documents incorporated by reference, above. In order to align video shots (including photographs) with boundaries defined by musical beat—i.e., make the video transition happened at the beat positions of the incidental music—the music analyzer 116 segments the music into several music sub-clips, whose boundary is at the beat position. Each video sub-shot (in fact, it is a shot in the generated background video) is shown during the playing of one music sub-clip. This not only ensures that the video shot transition occurs at the beat position, but also sets the duration of the video shot.

In an alternative implementation of the music analyzer 116, an onset (e.g. initiation of a distinguishable tone) may be used in place of the beat. Such use may be advantageous when beat information is not obvious during portions of the song. The strongest (e.g. loudest) onset in a window of time may be assumed to be a beat. This assumption is reasonable because there will typically be several beat positions within a window, which extends, for example, for three seconds. Accordingly, a likely location to find a beat is the position of the strongest onset.

The music analyzer 116 controls the length of the music sub-clips to prevent excessive length and corresponding audience boredom during the karaoke performance. Recall that the time-duration of the music sub-clip drives the time-duration during which the video sub-shots (or photos) are displayed. In general, changing the music sub-clip on the beat and with reasonable frequency results in the best performance. To give a more enjoyable karaoke performance, the sub-music should not be too short or too long. In one embodiment of the music analyzer 116, an advantageous length of sub-music clip is about 3 to 5 seconds. Once a first music sub-clip is set, additional music sub-clips can be segmented by the following way: given the previous boundary, the next boundary is selected as 11 the strongest onset in the window which is 3-5 seconds (an advantageous music sub-clip length) from the previous boundary.

Other implementations of the music analyzer 114 could be configured to set the music sub-clip length manually. Alternatively, the music analyzer 114 could be configured to set the music sub-clip length automatically, according to the tempo of the musical content. In this implementation, when the music tempo is fast, the length of music sub-clip is short; otherwise, the length of music sub-clip is long.

As will be seen below, after the lengths of each music sub-clip within the song are determined by the music analyzer 114, video sub-shot transition can be easily placed at the music beat position just by aligning the duration of a video shot and the corresponding music sub-clip.

A lyric form after 118 is configured to generate syllable-by-syllable rendering of the lyrics required for karaoke. In performing such a rendering, the lyric formatter 118 positions each syllable of the lyrics on the screen in alignment with the music of the selected song. To perform the rendering, each syllable is associated with a start time and a stop time, between which the syllable is emphasized, such as by highlighting, so that the singer can see what to sing. As seen in Table 1, the required information may be provided in an XML document.

The lyric formatter 118 may be configured to obtain an XML file such as that seen in Table 1, from a lyric service, which may operate on a pay-for-play service over the Internet. In this case, the lyric formatter 118 may obtain the lyrics through a network interface 126. The lyric service can be a charged service over the Internet, or can be located on the user's hard disk at 110.

A content selector 120 is configured to select visual content, i.e. videos or photographs, for segmentation and display as background to the karaoke lyrics. As aforementioned, the background video could be video segments from my videos 104 only, photographs from my photos 106 only, or a combination of video segments and photographs. Where the visual content selected includes both videos and photographs, each photograph can be regarded to be a shot (and also a sub-shot), and photograph groups can be regarded as “scenes.” The content selector may be configured to select video content using video content selection technologies used in “Systems and Methods for Automatically Editing a Video,” which was previously incorporated by reference.

To ensure that the selected video clips and/or photograph are of satisfactory quality, the content selector 120 incorporates two rules derived from studying professional video editing. By complying with the two rules, the content selector 120 is able to select suitable segments that are representative of the original video in content and of high visual quality. First, using a long unedited video as a karaoke background is boring, principally because of the redundant, low quality segments common in most home videos. Accordingly, an effective way to compose compelling video content for karaoke is to preserve the most critical features within a video—such as those that tell a story, express a feeling or chronicle an event—while removing boring and redundant material. In other words, the editing process should select segments with greater relative “importance” or “excitement” value from the raw video.

A second guideline indicates that, for a given video, the most “important” segments according to an importance measure could concentrate in one or in a few parts of the time line of the original video. However, selection of only these highlights may actually obscure the storyline found in the original video. Accordingly, the distribution of the selected highlight video should be as uniform along the time line as possible so as to preserve the original storyline.

The content selector 120 is configured to utilize these rules in selecting video sub-shots; i.e. to select the “important” sub-shots in a manner which results in selection of sub-shots distributed throughout the video. The configurations within the content selector 120 can be formulated as if to address an optimization problem, wherein two computable objectives include: selecting “important” sub-shots; and selected sub-shots in as nearly uniformly distributed a manner as possible. The first objective is achieved by examining the average attention index of each sub-shot. The second objective, distribution uniformity, is addressed by study of the normalized entropy of the selected shots distributed along the timeline of the raw home videos.

A karaoke composer 122 is typically configured in software. The karaoke composer 122 provides solutions for shot boundaries, music beats and lyric alignment. Additionally, the composer 122 is configured to convert a photograph or a series of photographs into videos. And still further, the composer 122 is configured for connecting video sub-shots with specific transitions within music sub-clips. In some implementations, the composer 122 is configured for applying transformation effects on shots and for supporting styles which support a “theme” to the karaoke presentation.

The karaoke composer 122 is configured to align sub-shot transitions with music beats (which typically define the edges of music sub-clips). To make the karaoke background video more expressive and attractive, the karaoke composer 122 puts shot transitions at music beats, i.e., at the boundaries between the music sub-clips. This alignment requirement is met by the following alignment 11 strategy. The minimum duration of sub-shots is made greater than maximum duration of music sub-clips. For example, the karaoke composer 122 may set music sub-clip duration in the range between 3 and 5 seconds, while sub-shots duration in 5 to 7 seconds. Since sub-shot durations are generally greater than music sub-clips, the karaoke composer 122 can shorten the sub-shots to match their duration to that of the corresponding music sub-clips. Another alignment issue is character-by-character or syllable-by syllable lyric rendering. Because the time for display and highlight of each syllable has been clearly indicated in the lyric file, the karaoke composer 122 is able to accomplish this objective.

In one implementation, the karaoke composer 122 is configured to support photo-to-video technology. Photo-to-video is a technology developed to automatically convert photographs into video by simulating temporal variation of people's study of photographic images using camera motions. When we view a photograph, we often look at it with more attention to specific objects or areas of interest after our initial glance at the overall image. In other words, viewing photographs is a temporal process which brings enjoyment from inciting memory or from rediscovery. This is well evidenced by noticing how many documentary movies and video programs often present a motion story based purely on still photographs by applying well-designed camera operations. That is, a single photograph may be converted into a motion photograph clip by simulating temporal variation of viewer's attention using camera motions. For example, zooming simulates the viewer looking into the details of a certain area of an image, while panning simulates scanning through several important areas of the photograph. Furthermore, a slide show created from a series of photographs is often used to tell a story or chronicle an event. Connecting the motion photograph clips following certain editing rules forms a slide show in this style, a video which is much more compelling than the original images.

The karaoke composer 122 may be configured to utilize the focal points discovered by the photo analyzer 114. As seen above, focal points are areas in a photograph that most likely will attract a viewer's attention or focus. These areas are used to determine the camera motions to be applied to the image, based on a similar technology as Microsoft Photo Story™.

In one implementation, the karaoke composer 122 is configured to produce a number of transitions and effects. For example, transformation effects provided by Microsoft Movie Maker 2 can be used to implement the karaoke composer 122, including grayscale, blurring, fading in/out, rotation, thresholds, sepia tone, etc. A number of effects provided by Microsoft DirectX and Movie Maker may also be included with the karaoke composer 122, including cross fade, checkerboard, circle, wipe, slide, etc. The transformation and transition effects can be selected randomly in a specific effect set, or determined by the styles. Simple rules for transition selection are also employed. For example, we use “cross fade” for the sub-shots/photographs in the same scene/group/day, use others randomly selected transitions as a new day/group/day comes out.

The karaoke composer 122 may include extensions, including different styles according to users' preference. As many styles may be defined as desired. Three exemplary styles are show below, namely, music video, day-by-day, and old movie, to show how the karaoke composer 122 may support different styles.

The karaoke composer 122 may be configured to produce a “music video” style. In this style, the karaoke composer 122 segments the music according to the tempo of the music. Accordingly, if the music is fast, the music sub-clip will be shorter, and vice versa. Then video segments and/or photographs are fused to the music to get the background video by the following rules for transformation effects and transition effects. Transformation effects may be achieved by applying effects—randomly selected from the entire effect set—on a randomly selected half of the sub-shots. Transition effects may be achieved by applying transitions—randomly selected from the entire transition set, except “cross fade”—to a randomly selected half of the sub-shots changes. For other sub-shots changes, we use “cross fade”.

The karaoke composer 122 may be configured to produce a “day-by-day” style. In this style, the karaoke composer 122 adds a title when the new day starts before the first sub-shot of the day to illustrate the creating date of the sub-shots coming next. Exemplary rules for transformation effects and transitions are defined below. Transformation effects may include a “fade in” effect which is added on the first sub-shots of each day, while a “fade out” effect is added on the last sub-shots of each day. Transition effects may include a “fade” between sub-shots that are in the same day, and use randomly selected effects when a new day begins.

The karaoke composer 122 may be configured to produce an “old movie” style. In this style, the karaoke composer 122 adds sepia tone or grayscale effect on all sub-shots, while only “fade right” transitions are used between sub-shots.

The karaoke composer 122 may be configured to resolve differences in the number of the sub-shots and the number of music sub-clips. In general, the karaoke composer 120 will dispose of extra sub-shots, in any of several ways. If 11 the number of sub-shots/photographs (after quality filtering and selecting) is less than the number of sub-music clips, repeat the sub-shots.

A user interface 124 on the karaoke apparatus 100 allows the user to select a song for use in the karaoke performance. In one embodiment of the karaoke apparatus 100, the user interface allows the user to hum a few bars of the song. The interface 126 then communicates with the database my music 108, from which one or more possible matches to the humming are presented. The user may select from one of them, repeat the process, or type in a song having a known title.

Exemplary Methods

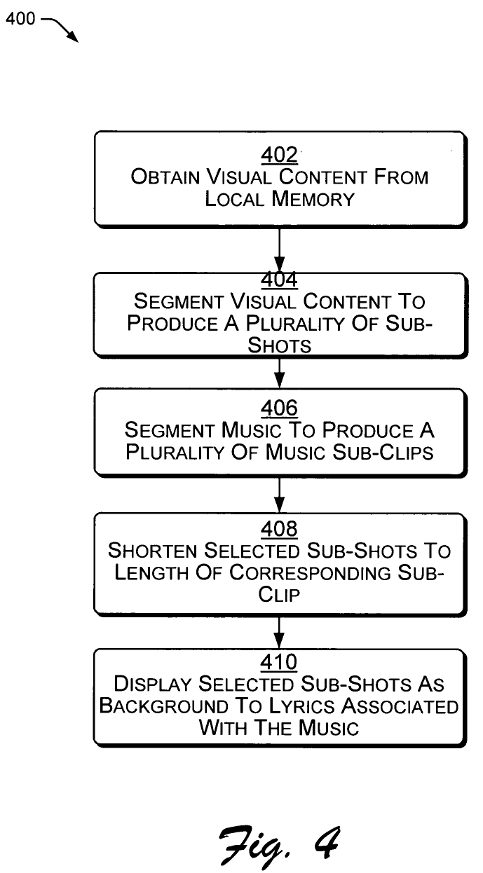

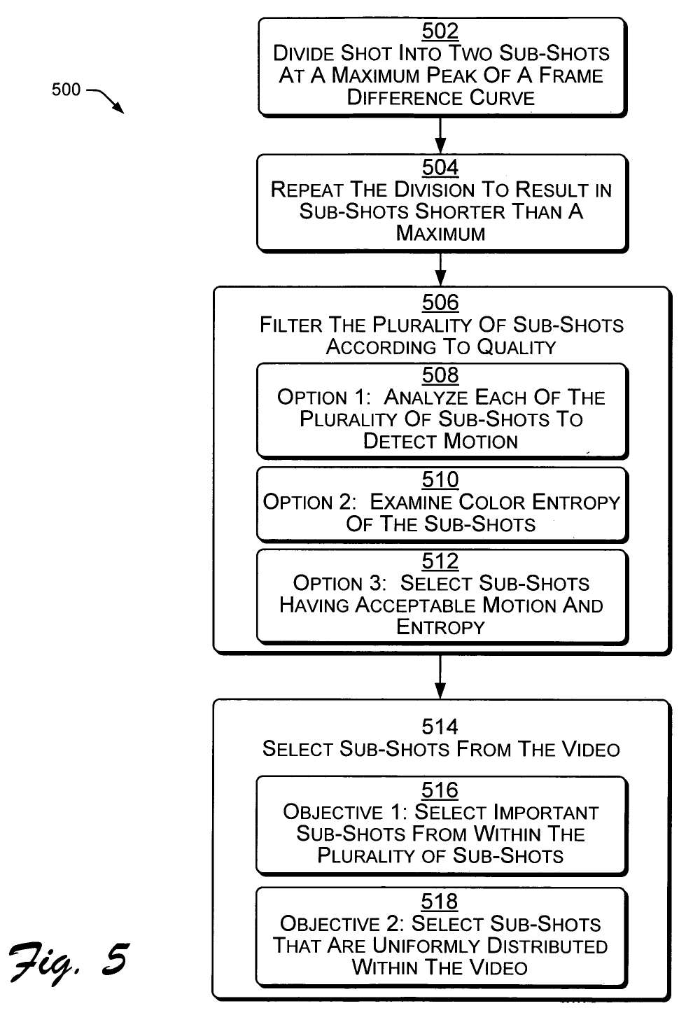

Exemplary methods for implementing aspects of personalized karaoke will now be described with primary reference to the flow diagrams of FIGS. 4-9. The methods apply generally to the operation of exemplary components discussed above with respect to FIGS. 1-3. The elements of the described methods may be performed by any appropriate means including, for example, hardware logic blocks on an ASIC or by the execution of processor-readable instructions defined on a processor-readable medium.

A “processor-readable medium,” as used herein, can be any means that can contain, store, communicate, propagate, or transport instructions for use by or execution by a processor. A processor-readable medium can be, without limitation, an electronic, magnetic, optical, electromagnetic, infrared, or semiconductor system, apparatus, device, or propagation medium. More specific examples of a processor-readable medium include, among others, an electrical connection having one or more wires, a portable computer diskette, a random access memory (RAM), a read-only memory (ROM), an erasable programmable-read-only memory (EPROM or Flash memory), an optical fiber, a rewritable compact disc (CD-RW), and a portable compact disc read-only memory (CDROM).

FIG. 4 shows an exemplary method 400 for implementing personalized karaoke. At block 402, visual content is obtained from local memory. In most cases, the visual content involves the personal home movies (usually digital video) and personal photo album (usually digital images) of the user. As seen in the exemplary implementation above, the multimedia data acquisition module 102 obtains visual content from my videos 104 and my photos 106.

At block 404, the visual content is segmented to produce a plurality of sub-shots. As seen above, the video analyzer 112 includes a parsing procedure to segment video. Similarly, at block 406, music is segmented to produce a plurality of music sub-clips. As seen in the exemplary implementation above, the music analyzer 116 is configured to segment music into sub-clips, typically at beat locations. At block 408, the video sub-shots are shortened, as needed, to a length appropriate to the length of corresponding music sub-clips. At block 410, during the karaoke performance, selected video sub-shots are displayed as background to lyrics associated with the music.

FIG. 5 shows another exemplary method 500 for handling of shots sub-shots obtained from video. At block 502, a video shot is divided into two sub-shots at a maximum peak of a frame difference curve. As seen in FIG. 2, the frame difference curve 200 indicates locations 1, 2 and 3 wherein the difference between adjacent frames is high. Accordingly, at block 502 the video shot may be divided into sub-shots at such a location.

At block 504, the division of sub-shots may be repeated to result in sub-shots shorter than a maximum value. Excessively long video sub-shots tend to result in boring karaoke performances.

At block 506, the plurality of sub-shots is filtered as a function of quality. As seen above, a quality detection procedure within the video analyzer 112 is configured to filter out poor quality video.

Several options may be performed, singly or in mass. In a first option seen at block 510, the color entropy of the sub-shots may be examined. As seen above, the video analyzer 112 examines color entropy as one factor in determining the quality of each sub-shot.

In a second option seen at block 508, each of the plurality of sub-shots is analyzed to detect motion. Motion, both of the camera and objects within the video, within limits, is generally indicative of higher quality video. Sometimes, good quality video frames also have low entropies, such as in videos of skiing events. Therefore, an implementation of the video analyzer 112 combines both motion analyses with the entropy approach, thereby reducing false assumptions of poor video quality. That is, the video analyzer 112 considers segments to possibly be of low quality only when both entropy and motion intensity are low.

At block 512, it is generally the case that sub-shots having acceptable motion and/or acceptable color entropy should be selected. Where both of these factors appear lacking, it is generally indicative of a poor quality sub-shot.

At block 514, an appropriate set of sub-shots is selected from the video. The selection is typically performed by the content selector 120, which may be configured to make the selection in a manner consistent with to two objectives. In a first objective, seen at block 516, important shots are selected from among the plurality of sub-shots. As an example seen above, the video analyzer 112 selects appropriate or “important” video segments or clips to compose a background video for display behind the lyrics during the karaoke performance. In a second objective, seen at block 518, the video analyzer selects sub-shots that are uniformly distributed within the video. By obtaining uniform distribution, all parts of the story told by the video are represented. One method that may be utilized to accomplish this objective includes the evaluation of the normalized entropy of the sub-shots within the video.

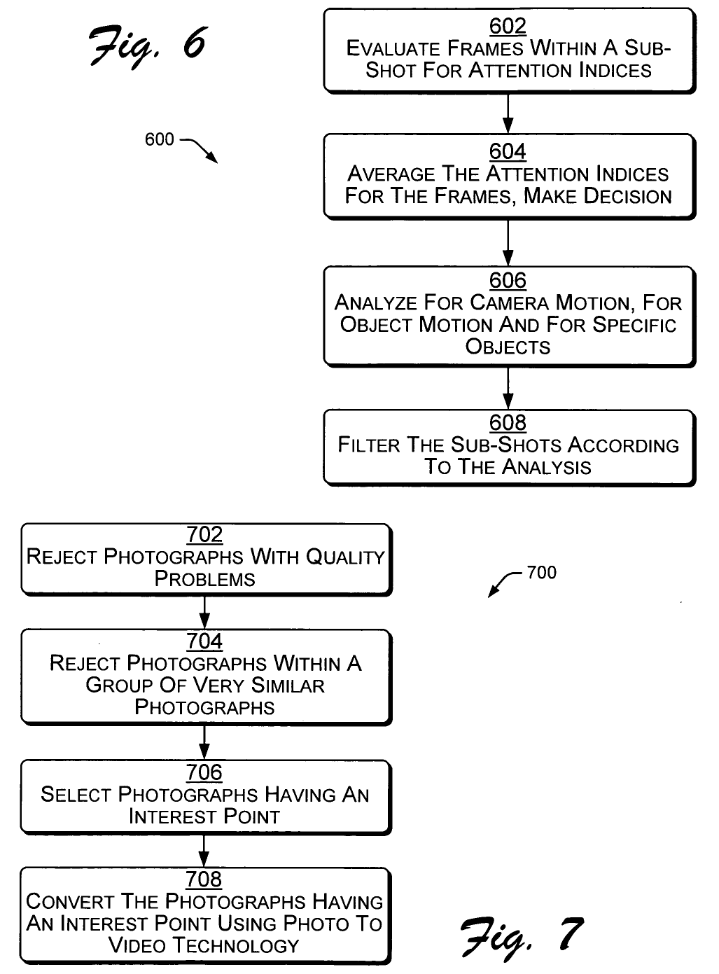

FIG. 6 shows an exemplary method 600 wherein attention analysis is applied to a video sub-shot selection process. At block 602, frames are evaluated within a sub-shot for attention indices. As seen above, one implementation of the video analyzer 112 was configured to produce an attention curve by calculating the attention/importance index of each video frame. At block 604, the importance index for each sub-shot is obtained by averaging the attention indices of all video fames within this sub-shot. Accordingly, sub-shots may be compared, and a selection between sub-shots made, based on their importance and predicted ability to hold an audience's attention.

At block 606, camera motion and object motion is analyzed. Generally, where the camera is moving (within limits), or where objects within the field of view are moving (again, within limits) the audience will be paying attention to the video. Additionally, analysis is made in an attempt to recognize specific objects, such as people's faces. Where faces are detected, additional audience interest is likely.

At block 608, the video analyzer 112 or similar apparatus filters the sub-shots according to the analysis performed at blocks 602-606.

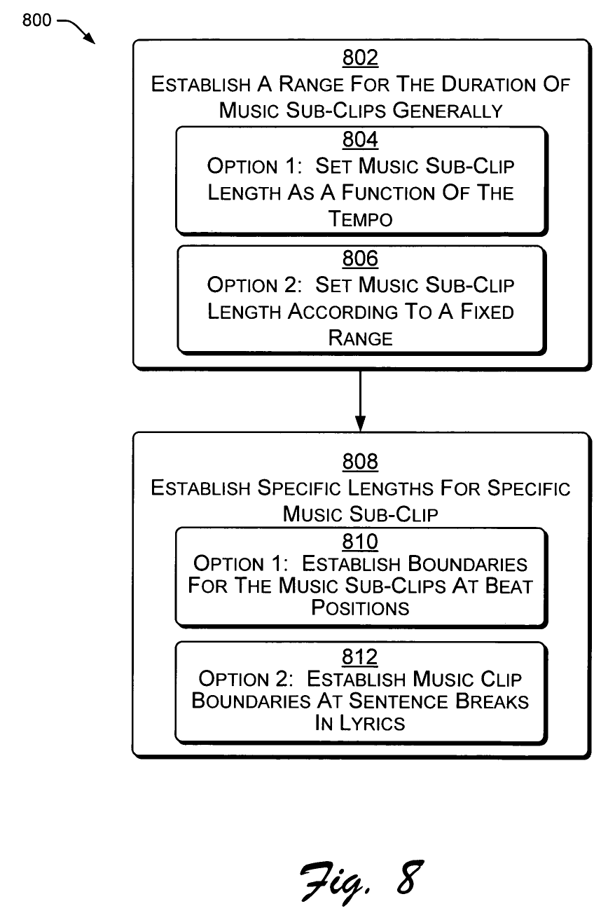

FIG. 7 shows another exemplary method 700 for processing of shots obtained from photographs. Blocks 702-708 may be performed by a photo analyzer 114, as seen above, or by similar software or apparatus. At block 702, the photo analyzer 114 rejects photographs having quality problems. As seen above, the quality problems can include under/over exposure, overly homogeneous images, blurred images, and others. At block 704, the photo analyzer 114 rejects (except, perhaps one) photographs within a group of very similar photographs. At block 706, the photo analyzer 114 selects photographs having an interest area. As seen above, a key interest area would be a human face; however, other interest points could be designated. At block 708, where a photograph having an interest area is selected, the photo analyzer 114 converts the photo to video. As seen above, the photo analyzer 114 typically uses panning and zooming to create a “video-like” experience from the still photograph.

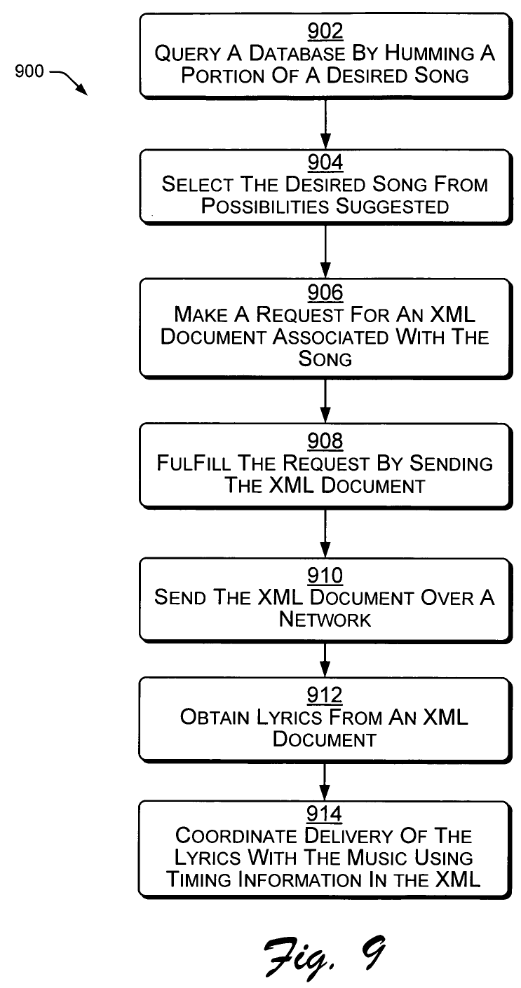

FIG. 8 shows another exemplary method 800 for processing of music sub-clips. At block 802, a range is set for the length of the music sub-clips generally (as opposed to the length of specific music sub-clips). In particular, at option 1 block 804, the range is set as a function of tempo. For example, the minimal length of the music sub-clips can be set at: minimum length=min {max {2*tempo,2},4}, in seconds. The maximum length of the music may be set at: maximum length=minimum+2, also in seconds.

At block 806, the music sub-clip length may be set to be within a fixed range, such as 3 to 5 seconds. Recall that the music sub-clip length is then matched by the length of the sub-shots. Accordingly, the sub-shot—video or photograph—will then change every 3 to 5 seconds. This rate of change may be fine-tuned as desired, in attempt to create the most interesting karaoke performance.

At block 808, specific lengths for specific music sub-clips are established. In blocks 802-806 the range of music sub-clips was determined. Here the karaoke composer 122 or other software procedure defines specific lengths for each music sub-clip. At block 810, the music sub-clip boundaries are established at beat positions, located according to the rhythm or tempo of the music. This produces changes in the video sub-shot at beat positions, which tends to generate interest and expectation among the karaoke audience. Alternatively, where the beat is erratic or overly subtle, the lengths of each music sub-clip can be set using the onset.

At block 812, the boundaries of the music sub-clips may be set at the boundaries of sentence breaks. This results in a new video sub-shot for every line of lyrics.

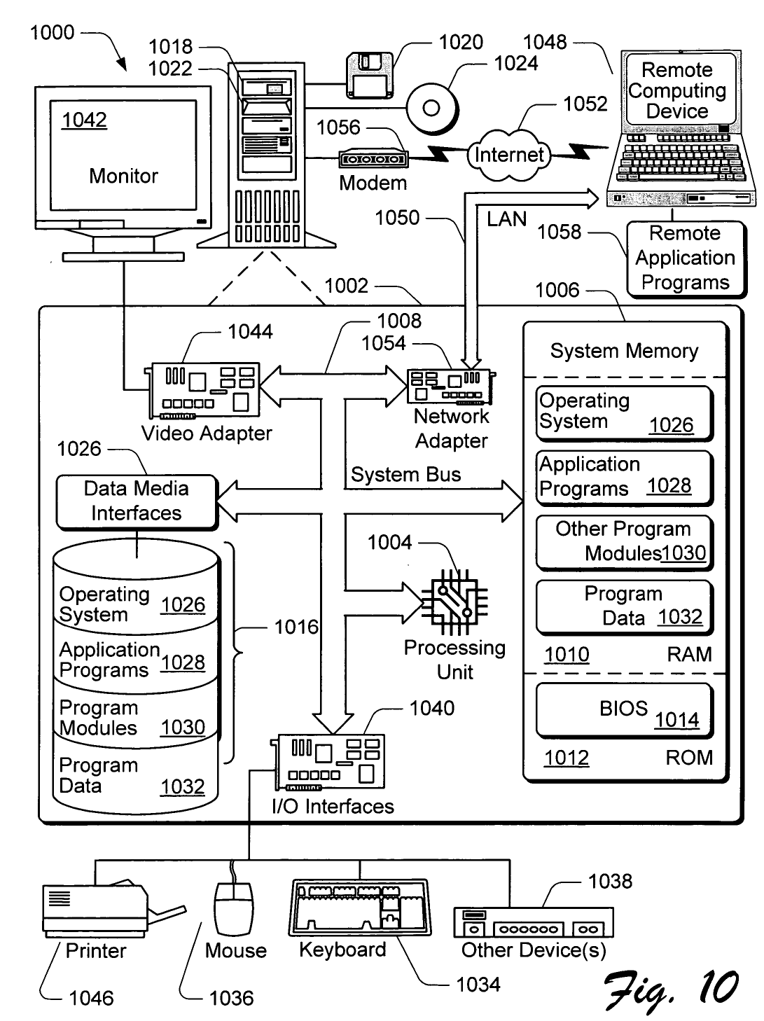

FIG. 9 shows another exemplary method 900 for processing of lyrics and related information. At block 902, the user may query a database by humming a portion of a desired song. For example, a user interface 124 may be configured to allow the user to hum the song. The user interface 124 could communicate with the database my music 108. At block 904, the user selects a desired song from among possible matches for the song. At block 906, in response to the selection of the desired song, a request for an XML document associated with the song is made. The request may be made to my lyrics 110, which may be on-site or off-site. At block 908, the request for lyrics is fulfilled. For example, a CD-ROM may provide a number of karaoke songs (vocal-less music) and associated XML lyrics documents. Such a disk may be purchased and located within the user's karaoke apparatus 100 (FIG. 1). Alternatively, the XML documents and karaoke songs may be off-site, and may be accessed over the Internet through the network interface 126. For example, FIG. 3 illustrates a karaoke apparatus 100 configured to communicate over a network 302 with a lyric service 300. At block 910, the XML document is sent over a network to the karaoke apparatus 100. In the example of FIG. 3, XML files—which may be configured as seen in Table 1—can be sent from the lyric service 300 to the karaoke apparatus 100.

At block 912 lyrics are obtained from an XML document. As was seen earlier in the discussion of Table 1, each syllable of the lyrics is present in the XML document, including a definition of the time slot within which the syllable should be displayed (within a sentence) and also highlighted during the performance. At block 914, the delivery of the lyrics is coordinated with the deliver of the music using timing information from the XML document. Accordingly, the lyrics are rendered, syllable by syllable, to the screen 224, with the correct timing.

While one or more methods have been disclosed by means of flow diagrams and text associated with the blocks of the flow diagrams, it is to be understood that the blocks do not necessarily have to be performed in the order in which they were presented, and that an alternative order may result in similar advantages. Furthermore, the methods are not exclusive and can be performed alone or in combination with one another.

Exemplary Computing Environment

FIG. 10 illustrates an example of a computing environment 1000 within which the application data processing systems and methods, as well as the computer, network, and system architectures described herein, can be either fully or partially implemented. Exemplary computing environment 1000 is only one example of a computing system and is not intended to suggest any limitation as to the scope of use or functionality of the network architectures. Neither should the computing environment 1000 be interpreted as having any dependency or requirement relating to any one or combination of components illustrated in the exemplary computing environment 1000.

The computer and network architectures can be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, gaming consoles, distributed computing environments that include any of the above systems or devices, and the like.

The computing environment 1000 includes a general-purpose computing system in the form of a computing device 1002. The components of computing device 1002 can include, by are not limited to, one or more processors 1004 (e.g., any of microprocessors, controllers, and the like), a system memory 1006, and a system bus 1008 that couples various system components including the processor 1004 to the system memory 1006. The one or more processors 1004 process various computer-executable instructions to control the operation of computing device 1002 and to communicate with other electronic and computing devices.

The system bus 1008 represents any number of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computing environment 1000 typically includes a variety of computer-readable media. Such media can be any available media that is accessible by computing device 1002 and includes both volatile and non-volatile media, removable and non-removable media. The system memory 1006 includes computer-readable media in the form of volatile memory, such as random access memory (RAM) 1010, and/or non-volatile memory, such as read only memory (ROM) 1012. A basic input/output system (BIOS) 1014, containing the basic routines that help to transfer information between elements within computing device 1002, such as during start-up, is stored in ROM 1012. RAM 1010 typically contains data and/or program modules that are immediately accessible to and/or presently operated on by the processing unit 1004.

Computing device 1002 can also include other removable/non-removable, volatile/non-volatile computer storage media. By way of example, a hard disk drive 1016 is included for reading from and writing to a non-removable, non-volatile magnetic media (not shown), a magnetic disk drive 1018 for reading from and writing to a removable, non-volatile magnetic disk 1020 (e.g., a “floppy disk”), and an optical disk drive 1022 for reading from and/or writing to a removable, non-volatile optical disk 1024 such as a CD-ROM, DVD, or any other type of optical media. The hard disk drive 1016, magnetic disk drive 1018, and optical disk drive 1022 are each connected to the system bus 1008 by one or more data media interfaces 1026. Alternatively, the hard disk drive 1016, magnetic disk drive 1018, and optical disk drive 1022 can be connected to the system bus 1008 by a SCSI interface (not shown).

The disk drives and their associated computer-readable media provide non-volatile storage of computer-readable instructions, data structures, program modules, and other data for computing device 1002. Although the example illustrates a hard disk 1016, a removable magnetic disk 1020, and a removable optical disk 1024, it is to be appreciated that other types of computer-readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 1016, magnetic disk 1020, optical disk 1024, ROM 1012, and/or RAM 1010, including by way of example, an operating system 1026, one or more application programs 1028, other program modules 1030, and program data 1032. Each of such operating system 1026, one or more application programs 1028, other program modules 1030, and program data 1032 (or some combination thereof) may include an embodiment of the systems and methods for a test instantiation system.

Computing device 1002 can include a variety of computer-readable media identified as communication media. Communication media typically embodies computer-readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

A user can enter commands and information into computing device 1002 via input devices such as a keyboard 1034 and a pointing device 1036 (e.g., a “mouse”). Other input devices 1038 (not shown specifically) may include a microphone, joystick, game pad, controller, satellite dish, serial port, scanner, and/or the like. These and other input devices are connected to the processing unit 1004 via input/output interfaces 1040 that are coupled to the system bus 1008, but may be connected by other interface and bus structures, such as a parallel port, game port, and/or a universal serial bus (USB).

A monitor 1042 or other type of display device can also be connected to the system bus 1008 via an interface, such as a video adapter 1044. In addition to the monitor 1042, other output peripheral devices can include components such as speakers (not shown) and a printer 1046 which can be connected to computing device 1002 via the input/output interfaces 1040.

Computing device 1002 can operate in a networked environment using logical connections to one or more remote computers, such as a remote computing device 1048. By way of example, the remote computing device 1048 can be a personal computer, portable computer, a server, a router, a network computer, a peer device or other common network node, and the like. The remote computing device 1048 is illustrated as a portable computer that can include many or all of the elements and features described herein relative to computing device 1002.

Logical connections between computing device 1002 and the remote computer 1048 are depicted as a local area network (LAN) 1050 and a general wide area network (WAN) 1052. Such networking environments are commonplace in offices, enterprise-wide computer networks, intranets, and the Internet. When implemented in a LAN networking environment, the computing device 1002 is connected to a local network 1050 via a network interface or adapter 1054. When implemented in a WAN networking environment, the computing device 1002 typically includes a modem 1056 or other means for establishing communications over the wide network 1052. The modem 1056, which can be internal or external to computing device 1002, can be connected to the system bus 1008 via the input/output interfaces 1040 or other appropriate mechanisms. It is to be appreciated that the illustrated network connections are exemplary and that other means of establishing communication link(s) between the computing devices 1002 and 1048 can be employed.

In a networked environment, such as that illustrated with computing environment 1000, program modules depicted relative to the computing device 1002, or portions thereof, may be stored in a remote memory storage device. By way of example, remote application programs 1058 reside on a memory device of remote computing device 1048. For purposes of illustration, application programs and other executable program components, such as the operating system, are illustrated herein as discrete blocks, although it is recognized that such programs and components reside at various times in different storage components of the computer system 1002, and are executed by the data processor(s) of the computer.

Although embodiments of the invention have been described in language specific to structural features and/or methods, it is to be understood that the invention defined in the appended claims is not necessarily limited to the specific features or methods described. Rather, the specific features and methods are disclosed as exemplary implementations of the claimed invention.

1. A processor-readable medium comprising processor-executable instructions for personalizing karaoke, the processor-executable instructions comprising instructions for:
segmenting visual content to produce a plurality of sub-shots;
segmenting music to produce a plurality of music sub-clips; and
displaying at least some of the plurality of sub-shots as a background to lyrics associated with the plurality of music sub-clips.

2. The processor-readable medium as recited in claim 1, additionally comprising instructions for:
shortening some of the plurality of sub-shots to a length of a corresponding music sub-clip from within the plurality of music sub-clips.

3. The processor-readable medium as recited in claim 1, wherein segmenting the visual content comprises instructions for:
dividing a shot into two sub-shots at a maximum peak of a frame difference curve; and
repeating the dividing to result in sub-shots shorter than a maximum sub-shot length.

4. The processor-readable medium as recited in claim 1, additionally comprising instructions for:
filtering the plurality of sub-shots according to importance; and
filtering the plurality of sub-shots according to quality.

5. The processor-readable medium as recited in claim 4, wherein filtering the plurality of sub-shots according to quality comprises instructions for:
examining color entropy within each of the plurality of sub-shots for indications of diffusion of color; and
if color entropy is low, analyzing each of the plurality of sub-shots to detect motion more that a threshold indicating interest and less than a threshold indicating low camera and/or object movement;
selecting sub-shots having acceptable motion and/or color entropy scores.

6. The processor-readable medium as recited in claim 4, wherein filtering the plurality of sub-shots according to importance comprises instructions for:
evaluating frames within a sub-shot according to attention indices; and
averaging the attention indices for the frames to determine if the sub-shot should be included or excluded.

7. The processor-readable medium as recited in claim 4, wherein filtering the sub-shots according to importance comprises instructions for:
analyzing for camera motion, for object motion and for specific objects within the sub-shots;
filtering the sub-shots according to the analysis.

8. The processor-readable medium as recited in claim 1, wherein the instructions for segmenting visual content segment video.

9. The processor-readable medium as recited in claim 8, additionally comprising instructions for:
selecting important sub-shots from within the plurality of sub-shots; and
selecting sub-shots such that they are uniformly distributed within the video.

10. The processor-readable medium as recited in claim 9, wherein selecting important sub-shots comprises instructions for:
evaluating color entropy, camera motion, object motion and object detection; and
selecting the important sub-shots based on the evaluation.

11. The processor-readable medium as recited in claim 9, wherein selecting uniformly distributed sub-shots comprises instructions for:
evaluating normalized entropy of the sub-shots along a time line of video from which the sub-shots were obtained.

12. The processor-readable medium as recited in claim 1, wherein the instructions for segmenting visual content includes instructions for assigning photographs to be sub-shots.

13. The processor-readable medium as recited in claim 12, wherein the instructions for assigning photographs includes instructions for:
rejecting photographs having problems with quality; and
rejecting photographs within a group of very similar photographs wherein a photo within the group has been selected.

14. The processor-readable medium as recited in claim 12, wherein the instructions for assigning photographs includes instructions for:
converting at least one of the photographs to video.

15. The processor-readable medium as recited in claim 1, wherein the visual content comprises home video and photographs in digital formats.

16. The processor-readable medium as recited in claim 1, wherein segmenting the music comprises instructions for:
establishing boundaries for the music sub-clips at beat positions within the music.

17. The processor-readable medium as recited in claim 1, wherein segmenting music into the plurality of music sub-clips comprises instructions for bounding music sub-clip length according to:
minimum length=min {max {2*tempo,2},4} and
maximum length=minimum+2.

18. The processor-readable medium as recited in claim 1, wherein segmenting the music comprises instructions for:
establishing music sub-clips' length within a range of 3 to 5 seconds.

19. The processor-readable medium as recited in claim 18, wherein segmenting the music comprises instructions for:
establishing boundaries for the music sub-clips at sentence breaks.

20. The processor-readable medium as recited in claim 1, additionally comprising instructions for:
obtaining the lyrics from a file; and
coordinating delivery of the lyrics with the music using timing information contained within the file.

21. A processor-readable medium as recited in claim 20, wherein obtaining the lyrics comprises instructions for sending the file over a network to a karaoke device as a part of a pay-for-play service.

22. The processor-readable medium as recited in claim 1, additionally comprising instructions for:
querying a database of songs by humming a portion of a desired song; and selecting the desired song from among a number of possibilities suggested by an interface to the database.

23. A processor-readable medium comprising processor-executable instructions for providing lyrics for integration with music suitable for karaoke, the processor-executable instructions comprising instructions for:
receiving a request for a file associated with a specified song, wherein the file:
associates each syllable contained within the lyrics with timing values; and associates each sentence contained within the lyrics with timing values; and fulfilling the request for the file by sending the file associated with the specified song.

24. A processor-readable medium as recited in claim 23, wherein obtaining the lyrics comprises instructions for sending the file over a network to a karaoke device.

25. A personalized karaoke device, comprising:
a music analyzer configured to create music sub-clips of varying lengths according to a song; a visual content analyzer configured to define and select visual content sub-shots; a lyric formatter configured to time delivery of syllables of lyrics of the song; and a composer configured to assemble the music-sub clips with the visual content sub-shots, and configured to adjust length of the sub-shots to correspond to the music sub-clips, and configured to superimpose the syllables of the lyrics of the song over the sub-shots.

26. The personalized karaoke device of claim 25, wherein the music analyzer is configured to segment the song with a strong onset between each of the music sub-clips.

27. The personalized karaoke device of claim 25, wherein the music analyzer is configured to segment the song with a beat between each of the music sub-clips.

28. The personalized karaoke device of claim 25, wherein the music analyzer is configured to segment the song automatically into sub-clips, each having a duration that is a function of song tempo.

29. The personalized karaoke device of claim 25, wherein the visual content analyzer is configured to segment video into sub-shots.

30. The personalized karaoke device of claim 25, wherein the visual content analyzer is configured to access folders of home video and photographs containing content from which the sub-shots are derived.

31. The personalized karaoke device of claim 25, wherein the visual content analyzer is configured to assemble still photographs, each of which is a sub-shot.

32. The personalized karaoke device of claim 25, wherein the visual content analyzer is configured to select from among sub-shots according to ranked importance, wherein importance is gauged by detection of color entropy, detection of object motion within the sub-shot, detection of camera motion during the sub-shot, and/or detection of a face within the sub-shot.

33. The personalized karaoke device of claim 25, wherein the visual content analyzer is configured to filter out sub-shots having low image quality as measured by low entropy and low motion intensity.

34. The personalized karaoke device of claim 25, wherein the visual content analyzer is configured to select sub-shots of greater importance consistent with creating a uniform distribution of the sub-shots over a runtime of a source video.

35. The personalized karaoke device of claim 25, wherein the visual content analyzer is configured to reject photographs of low quality by detecting over and under exposure, overly homogeneous images and blurred images.

36. The personalized karaoke device of claim 25, wherein the visual content analyzer is configured to organize photographs by date of exposure and by scene, thereby obtaining photographs having a relationship.

37. The personalized karaoke device of claim 37, wherein the visual content analyzer is configured to reject photographs which are members within a group of very similar photographs, wherein one of the group has already been selected.

38. The personalized karaoke device of claim 25, wherein the visual content analyzer is configured to:
detect an attention area within a photograph; and
create a photo to video sub-shot based on the attention area, wherein the video includes panning and/or zooming.

39. The personalized karaoke device of claim 25, wherein the lyric formatter is configured to consume a file detailing timing of each syllable and each sentence of the lyrics.

40. An apparatus, comprising:
means for creating music sub-clips of varying lengths according to a song;
means for defining and selecting visual content sub-shots;
means for timing delivery of syllables of lyrics of the song; and
means for assembling the music sub-clips with the visual content sub-shots, and to adjust length of the sub-shots to correspond to length of the music sub-clips, and to superimpose the syllables of the lyrics of the song over the sub-shots.

41. The apparatus of claim 40, wherein the means for defining and selecting visual content sub-shots is a video analyzer configured to segment video into sub-shots.

42. The apparatus of claim 40, wherein the means for defining and selecting visual content sub-shots is a video analyzer configured to access folders of home video and photographs containing content from which the sub-shots are derived.

43. The apparatus of claim 40, wherein the means for defining and selecting visual content sub-shots is a video analyzer configured for:
detecting an attention area within a photograph; and
creating a photo to video sub-shot based on the attention area, wherein the video includes panning and zooming.

44. The apparatus of claim 40, wherein the means for timing delivery of syllables of lyrics of the song is a lyric formatter configured for consuming a file detailing timing of each syllable and each sentence of the lyrics and for rendering the lyrics syllable by syllable.
